(19) United States
(12) Patent Application Publication
(10) Pub. No.: US 2010/0154940 A1
(43) Pub. Date: Jun. 24, 2010

(54) MELT-TREATED RIM OF A PISTON COMBUSTION BOWL

(75) Inventors: Jochen Luft, Bad Wimpfen (DE); Thomas Steffens, Bad Rappenau (DE); Christian Schaller, Billigheim (DE); Bernd Sartorius, Brackenheim (DE)

Correspondence Address: YOUNG BASILE, 3001 WEST BIG BEAVER ROAD, SUITE 624, TROY, MI, 48084, US

(73) Assignee: KS KOLBENSCHMIDT GMBH, Neckarsulm (DE)

(21) Appl. No.: 12/600,664

(22) PCT Filed: Apr. 25, 2008
(86) PCT No.: PCT/EP2008/003343

§ 371 Date: Nov. 18, 2009

(30) Foreign Application Priority Data
Jun. 29, 2007 (DE) 10 2007 030 301.9
Sep. 19, 2007 (DE) 10 2007 044 696.0

(51) Int. Cl. C22F 1/00; C21D 1/42; C21D 1/34; H05B 6/10

(52) U.S. Cl. 148/512; 219/121.66; 219/602

(57) ABSTRACT

A method for producing pistons that can be used in internal combustion engines made from lightweight metal, with a combustion bowl assigned to one piston head, wherein a bowl rim is subjected to a melt treatment. In a first method step, the bowl rim is inductively heated. In a second method step, the material of the bowl rim, also to be referred to as the delimiting zone, is improved by means of a laser beam.

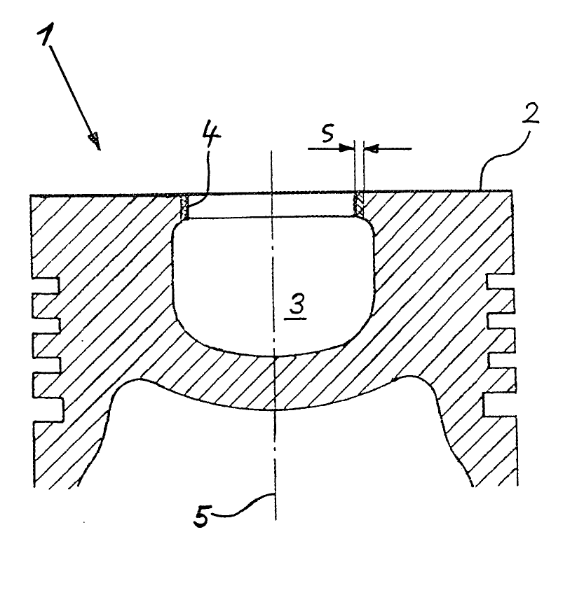

### BACKGROUND

This disclosure relates to a method for producing pistons of lightweight metal that can be used in internal combustion engines that have a combustion bowl allocated to a piston crown and subjected to a melt treatment at least in some areas.

The combustion bowl in a piston is especially severely thermally and cyclically stressed in the operating mode, with the attendant risk of crack formation. It is known in order to prevent crack formation to introduce inserts of a heat-resistant steel or of metal-ceramic materials into the piston crown. The disadvantage of such inserts is that they increase the weight of the lightweight metal piston and possess poor heat conductivity, as a result of which the surrounding lightweight metal heats up in operation to a temperature that results in a loss of strength. In addition, disadvantageous stresses are created due to the difference in thermal expansion rates of the insert and the lightweight metal.

It is further known to improve materials by remelting. This method is based on the fact that a charge carrier beam penetrating the material melts a small quantity of material in its immediate vicinity, while the area surrounding the melt zone remains cold, and the molten material therefore cools rapidly and hardens again immediately after the charge carrier is removed or moves on.

The remelting improves surface strength and surface hardness. The change in material properties is based on structural reconfigurations brought about by melting and quenching processes.

Improving a piston by remelting is known from DE 21 24 595 in which a charge carrier beam penetrates the material. The disadvantage of this method is that only a small material zone located in the immediate area of the charge carrier beam is melted. To produce a piston with a combustion bowl in accordance with DE 10 2005 034 905 A1, the base of the bowl is melt-treated with the object of changing the material in the melt-treated, remelted area at a specifiable depth. From DE 80 28 685 U1, it is known to carry out remelt treatment in order to create locally determined stress conditions in the piston material that have an advantageous effect when the piston is in an operating mode. JP 59 108 849 discloses an electron beam, laser, plasma or TIG process in which partial remelting of an area of the piston crown base is achieved using high energy density. DE 10 335 843 A shows remelting of individual areas of the piston by means of inductive heating. This method has the disadvantage of limited penetration that directly determines the efficacy of the material remelting. Document EP 03 003 100 further discloses a method for producing a piston in which an arc-welding process is provided for the melt treatment.

It would be desirable to implement a piston that has an improved material structure locally in the area of a highly stressed zone of the combustion bowl to increase its service life.

### SUMMARY

The invention provides for a combination method encompassing two steps. The rim of the combustion bowl proposed for remelting is inductively heated in a first process step. Then, the material of the rim, also designated as a delimiting zone, is remelted by means of a laser beam in a second process step and thereby improved. These process steps are performed within a short interval of time, to the extent possible following immediately one after the other. Alternatively, the invention also includes material remelting in which laser remelting is provided as the first process step followed by inductive heating.

The required penetration is achieved using the laser remelt process. Remelting performed exclusively by means of a laser beam is characterized by severe pore formation, caused by overheating of the melt and by the associated increased absorption of gas. On the other hand, the penetration sought for remelting cannot be achieved using pure inductive heating. The desired effective remelt depth can be achieved by the combined method in accordance with the invention, wherein overheating of the melt is avoided at the same time.

By melting a delimited zone of the combustion bowl in the area of the rim and from the rapid hardening characteristic of the process, a low-oxide and finer grain material structure in the rim is achieved that increases strength, and the risk of crack formation is effectively reduced. The combination process additionally ensures that any oxides present in the rim are broken down.

The material in the melt-treated layer has a modified structure compared with the piston material lying thereunder, incorporating a smaller particle size, as the result of which the material properties, specifically structural strength and consequently rigidity, are improved. By means of the combination process in accordance with the invention, the crystallization processes of the casting structure, specifically of the thermally highly stressed piston area, are advantageously affected, combined with improved fatigue strength. The remelting in accordance with the invention counteracts piston failure in the rim, for example, because of changes in temperature distribution. The locally delimited melt-treated area of the rim outside the remaining functional surfaces is sufficient to achieve an efficacious result. This measure, which can be implemented economically through the invention, increases service life and thus the cost-effectiveness of the inventive piston produced from lightweight metal.

A device is disclosed that ensures the steps of the method are carried out. To this end, a device is constructed that encompasses both remelting the material of the rim by means of inductive heating as well as laser beam treatment. These actions take place synchronously or in a chronologically short sequence to achieve a local effect on the structural conditions in the area of the rim. A material structure is realized thereby which, compared with the untreated areas of the piston at a definable depth, is modified in such a way that improved strength and, associated with it, increased service life result. The construction of the device for material remelting can advantageously also provide an alternative sequence for the two-stage melt treatment in which a laser beam treatment is carried out first, followed by the inductive heating.

As an alternative to a circumferentially melt-treated rim, the invention encompasses partially melt-treated areas of the rim in order to take account of specific, in particular different, thermal stresses in the piston crown and the combustion bowl.

The piston treated by the method in accordance with the invention consists preferably of aluminum or an aluminum alloy. These non-ferrous materials possess the advantage that they are not magnetic, with the result that a tendency for the metal to flow is reduced, in particular during the inductive heating. This can ensure that the steps of the method in accordance with the invention are confined to the desired layer thickness.

The steps of the method within the scope of the invention, i.e., the inductive heating and the laser beam treatment, are preferably performed following a final machining of the piston to shape, at least of the combustion bowl. This provides a cost benefit compared with previous methods for remelt treatment in which the melt-treated areas required rework with respect to their shape.

The heat-treated material zone is, in accordance with the invention, remelted to a depth of≧150 μm to≦2 mm. Based on the steps of the method from the invention, however, it is possible to realize a deeper remelt treatment at no great additional expense. This can be of advantage, when, for example, specific areas of the surface are reworked by metal removal following the remelting without the remelted material layer being completely lost. As the result of the power of the laser beam used and of the inductive heating and/or the application time, a depth for the melt-treated layer can be controlled.

Once the remelt treatment is completed, a cooling rate between 150-1050 K/sec is provided in accordance with the invention. The rapid hardening of the molten surface layer effects a structural reformation in which a desirable granular refinement occurs in which the particles in the melt crystallize into a finer grain. A cooling rate of 250-600 K/sec is preferably provided for the melt-treated rim.

### DETAILED DESCRIPTION OF THE DRAWING

The invention is explained in more detail in what follows using one aspect with reference to one FIGURE.

### DETAILED DESCRIPTION

The single FIGURE shows a piston 1 in accordance with the invention in a longitudinal section, where the representation is essentially limited to the piston upper part. A largely cylindrically shaped combustion bowl 3 extending far into the piston 1 is assigned a piston crown 2 of the piston 1, the bowl narrowing towards the piston crown 2 by means of a rim 4. The rim of the bowl 4 undergoes limited melt-treatment using a procedure involving two steps as a measure to achieve improved, increased surface strength and surface hardness. In order to perform the steps, the piston 1, which is positioned in a device, not shown in the FIGURE, is rotated about its longitudinal axis. The device further includes measures to heat a local area, i.e., a rim 4 of the combustion bowl 3, selectively by induction and using a laser beam. The thermally treated, or improved, depth “S” of the remelt zone of the rim 4 extends to a dimension between≧150 μm to≦2 mm.

What is claimed:

1. A method for producing pistons of lightweight metal for use in internal combustion engines having a combustion bowl assigned to a piston crown comprising the steps of:
at least some areas of a piston to a melt treatment, including a step of inductive heating of a rim of the combustion bowl and a step of remelting of the material in the area of the rim by means of a laser beam.

2. The method of claim 1, wherein, as an alternative to a circumferentially melt-treated rim, individual sectors of the rim are treated.

3. The method of claim 1, wherein aluminum and an aluminum alloy is provided as material for the piston.

4. The method of claim 1, wherein the melt treatment is performed following completion of finish machining of the rim.

5. The method of claim 1, wherein remelting of the rim takes place to a depth of≧150 μm to≦2 mm.

6. The method of claim 1, further comprising the step of:
cooling of the material following completion of the melt treatment of the rim takes place at a rate of 150 to 1050 K/sec.

7. The method of claim 1 further comprising the step of:
rotating the piston about its longitudinal axis during the melt treatment.

8. A device for performing the steps in accordance with claim 1, with which a piston of lightweight metal for use in internal combustion engines can be produced, wherein a combustion bowl is allocated to a piston crown of the piston, the rim of the bowl is melt-treated by means of inductive heating and a subsequent laser beam to achieve a localized change in the structure, the device remelting of the material of the rim by means of inductive heating and a laser beam treatment.
